(19) United States
(12) Patent Application Publication
(10) Pub. No.: US 2015/0204123 A1
(43) Pub. Date: Jul. 23, 2015

(54) HINGE

(71) Applicant: Caldwell Hardware (UK) Limited, Coventry (GB)

(72) Inventor: Neal Desorgher, Coventry (GB)

(21) Appl. No.: 14/602,928

(22) Filed: Jan. 22, 2015

(30) Foreign Application Priority Data
Jan. 22, 2014 (GB) 1401029.2
Jul. 14, 2014 (GB) 1412484.6

(51) Int. Cl. E05D 5/14; E06B 3/34; E06B 3/48; E06B 3/70

(52) U.S. Cl. CPC E05D 5/14; E06B 3/70; E06B 3/34; E06B 3/48

(57) ABSTRACT

We provide a hinge comprising: a first leaf for connection to a first object and a second leaf for connection to a second object, a pivot pin, and a convex bearing defining an opening for receiving a portion of the pivot pin, the first leaf including a first retaining portion surrounding a first portion of the pivot pin, and the second leaf including a second retaining portion surrounding a second portion of the pivot pin, for relative rotation of the first leaf and second leaf about an axis of rotation defined by the pivot pin, the axis of rotation being rotatable about the bearing.

### DESCRIPTION OF INVENTION

The present invention relates to a hinge of the sort particularly, but not exclusively, for use in folding doors or windows.

Doors formed from single or multiple panels are well known. Multiple panel doors generally include hinges and/or other forms of connector that require adjacent panels to pivot and/or slide relative to one another. For aesthetic reasons it is preferable that the hinges or connectors are substantially hidden from view when the door is closed. To enable this, the connectors typically include hinges with multiple pivot points and multiple sliding parts that allow the panels to move towards and/or away from each other so that they may ‘fold back’ on themselves, with the hinge unit positioned out of view between the folded panels.

Connectors with multiple pivot points create ‘false’ pivot points that are offset from the hinge itself, to enable the door panels to move towards and/or away from each other as they fold. This is achieved using complex configurations of link bars to create the desired relative movement between the panels, and through use of sliding joints.

A problem associated with known hinges is that large operating forces are required to move panels of doors connected with the hinges, and it is common for the hinges to lock up during use so that the door cannot be opened or closed. Such lock ups also occur where multiple hinges are connected between a pair of adjacent panels—typically three or four hinges may be provided—where inline hinges become misaligned. Slight rotational misalignment between the respective axes of rotation of the hinges results in the folding components becoming stuck. It is very difficult to align multiple hinges perfectly during installation, and installation can be time intensive with no guarantee of achieving accurate alignment.

According to an aspect of the present invention we provide a hinge comprising:

a. a first leaf for connection to a first object and a second leaf for connection to a second object,
b. a pivot pin, and
c. a convex bearing defining an opening for receiving a portion of the pivot pin,
d. the first leaf including a first retaining portion surrounding a portion of the pivot pin, and the second leaf including a second retaining portion surrounding a portion of the pivot pin, for relative rotation of the first leaf and second leaf about an axis of rotation defined by the pivot pin, the axis of rotation being rotatable about the bearing.

The convex bearing may be a ball bearing.

The first leaf may provide a seat for rotatably retaining the convex bearing within the first retaining portion.

The first leaf may provide a first bearing bush arrangement positioned substantially within the first retaining portion and which surrounds a first portion of the pivot pin.

The first bearing bush arrangement may provide the seat.

The internal diameter of the first bearing bush arrangement may be larger than the diameter of the pivot pin so as to enable angular movement of the pivot pin within the first bearing bush arrangement about an axis perpendicular to its longitudinal axis.

The difference between the internal diameter of the first bearing bush arrangement and the diameter of the pivot pin may be between 0.1 mm and 1 mm.

The first bearing bush arrangement may comprise a first part and a second part each having a bearing-facing end and an outer end, the bearing-facing ends each forming a concave rim to abut a surface of the convex bearing such that the seat is formed between the bearing-facing ends of the first part and second part of the first bearing bush arrangement.

The opening defined by the convex bearing may be an aperture defined through the convex bearing, and the pivot pin extends through the convex bearing.

The second leaf may include a third retaining portion surrounding a third portion of the pivot pin.

The second portion of the pivot pin may be disposed towards a first end of the pivot pin and the third portion of the pivot pin is disposed towards a second end of the pivot pin opposite to the first end.

The first retaining portion may be disposed between the second and third retaining portions and the first portion of the pivot pin is disposed centrally lengthwise of the pivot pin.

The outer ends of the first and second parts of the first bearing bush arrangement may each form convex rims adapted to abut a corresponding concave ring formed at respective bearing-facing ends of second and third bearing bushes positioned substantially within the second and third retaining portions, respectively, and surrounding second and third portions of the pivot pin.

The respective inner ends of the second and third bearing bushes may each provide a rim that extends radially outwardly so as to abut an end of respective second and third retaining portions.

The first leaf may include: a first body connected to the first retaining portion, and a first connection part for connection to the first object, the first connection part being pivotally connected to the first body, and the second leaf may include: a second body connected to the second retaining portion and third retaining portions, and a second connection part for connection to the second object, the second connection part being pivotally connected to the second body.

The hinge may further include a first support member having a first end and a second end, the first end being pivotally connected to the first body and the second end being pivotally connected to the second leaf.

The hinge may further include a second support member having a first end and a second end, the first end being pivotally connected to the second body and the second end being pivotally connected to the first leaf.

The hinge may include a pair of second support members.

The first support member may be connected at its second end to the second connection part, and the second support member(s) may be connected at its second end to the first connection part.

According to a further aspect of the invention we provide a door comprising a first and a second door panel, the first and second door panels being connected to one another using a hinge according to the first aspect of the invention.

Embodiments of the invention will now be described, by way of example only, with reference to the following figures, of which:

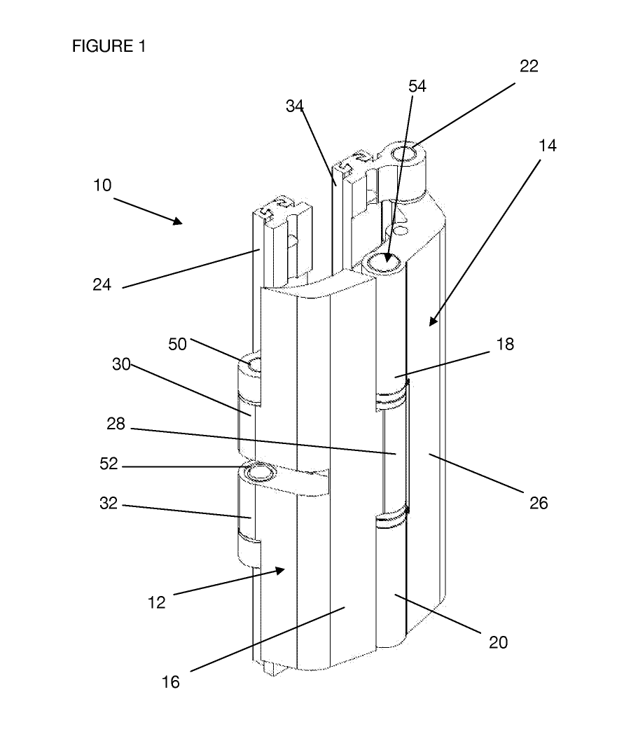

FIG. 1 is a perspective view of a hinge according to embodiments of the present invention;

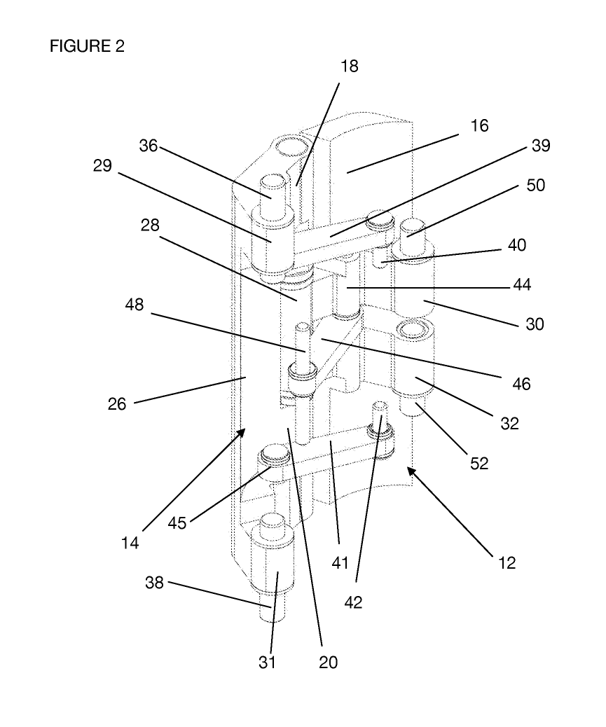

FIG. 2 is a perspective view of the hinge of FIG. 1;

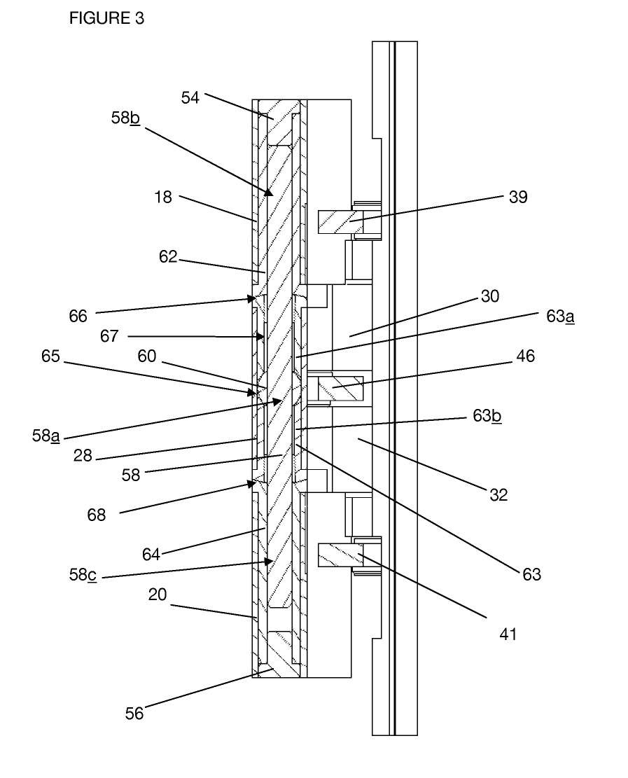

FIG. 3 is a cross-sectional view of the hinge of FIG. 1; and

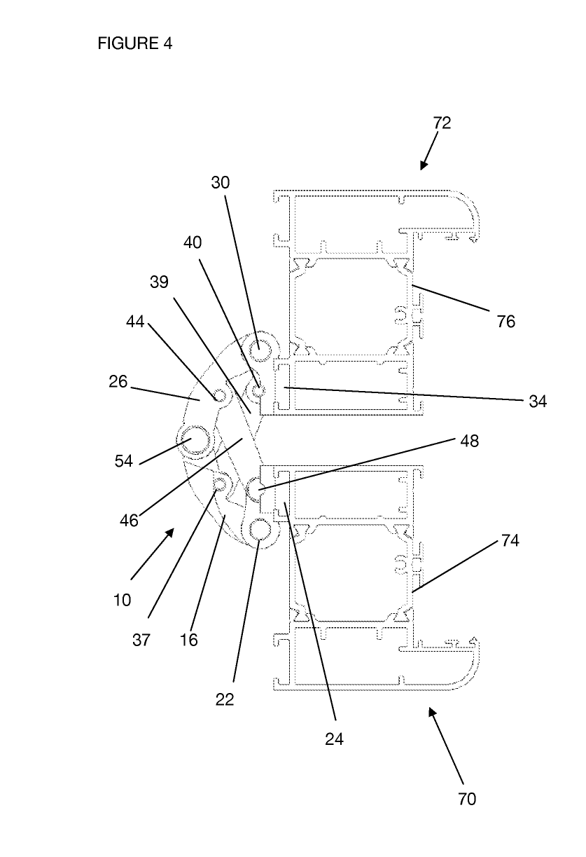

FIGS. 4 to 6 are plan views of a hinge according to embodiments of the invention shown in respective open, intermediate and closed positions respectively, and in relation to first and second objects.

With reference to FIGS. 1, 2 and 3 of the drawings, a hinge 10 is provided, the hinge comprising a first leaf 12 for connection to a first object and a second leaf 14 for connection to a second object. The hinge 10 is described in the context of a folding multi-panel door, where it is used to connect two adjacent panels of the door, and in which case the first and second objects are first and second panels of the door. For simplicity those objects shall be referred to as first and second door panels throughout the rest of the description. It should be understood that the hinge 10 is also suitable for connecting panels of windows, shutters, or the like, and or for connecting doors or windows to respective frames.

The first leaf 12 and second leaf 14 are pivotable relative to one another about a pivot pin 58. The pivot pin 58 is housed within a channel formed between a two or more substantially cylindrical retaining portions forming a sleeve in which the pivot pin 58 may rotate about its longitudinal axis. The first leaf 12 includes a first retaining portion 28 substantially surrounding a first portion 58a of the pivot pin 58, and the second leaf 14 includes a second retaining portion 18 substantially surrounding a second portion 58b of the pivot pin 58, for relative rotation of the first leaf 12 and second leaf 14 about an axis of rotation defined by the pivot pin 58, the axis of rotation being rotatable about a convex bearing 60. In embodiments, and as shown in FIGS. 1 to 3, the second leaf 14 includes a third retaining portion 20 surrounding a third portion of the pivot pin.

The bearing 60 is a ‘convex bearing’, by which we mean it provides a surface that is curved in more than one plane. In this way the convex bearing forms a domed outer surface. For example, the surface is curved in a plane parallel with the axis defined by the pivot pin 58, and is curved in the plane orthogonal to the axis of the pivot pin 58 (as opposed to a flat washer, for example, the outer rim of which is curved only in the plane orthogonal to its central axis). In embodiments the bearing 60 is a ball bearing.

Where used herein, the terms ‘convex’ and ‘concave’ are not to be interpreted to be restricted to portions that are exactly part-spherical; a generally curved portion is suitable, which need not have a constant radius or constant curvature.

As shown in the Figures, the second portion 58b of the pivot pin 58 is disposed towards a first end and the third portion 58c of the pivot pin 58 is disposed towards a second end opposite to the first end. In embodiments, and as shown in the Figures, the first retaining portion 28 is disposed between the second and third retaining portions 18, 20 and the first portion of the pivot pin 58a is disposed approximately centrally lengthwise of the pivot pin 58.

In the embodiment shown, the first leaf 12 includes a first body 16 connected to the first retaining portion 28, and the second leaf 14 includes a second body 26 connected to the second retaining portion 18 and third retaining portion 20. The first leaf 12 includes a first connection part 24 for connection to the first door panel 70, the first connection part 24 being pivotally connected to the first body 16, and the second leaf 14 includes a second connection part 34 for connection to the second door panel 72, the second connection part being pivotally connected to the second body 26.

The first connection part 24 is pivotally connected to the first body 16 via a pair of pins 50, 52 held rotatably in a pair of bushes 30, 32 defined by the first body 16, such that the pins 50, 52 engage respective bushes defined by the connection part 24. The second connection part 34 is pivotally connected to the second body 26 via a pair of pins 36, 38 held rotatably in a pair of bushes 29, 31 defined by the second body 26, in the same manner, for connection with a respective pair of bushes 22 defined in the second connection part 34.

The hinge 10 further includes a first support member 46 having a first end and a second end, the first end being pivotally connected to the first body 16 and the second end being pivotally connected to the second leaf 14. In particular, and as shown in FIGS. 4 to 6, the first support member 46 is pivotally connected to the second connection part 34 of the second leaf 14. It is envisaged that at least one first support member 46 may be provided.

The hinge also includes at least one and preferably a pair of second support members 39, 41 each having a first end pivotally connected to the second body 26, and a second end pivotally connected to the first leaf 12, and in particular to the first connection part 24 of the first leaf 12. The second support members 39, 41 may be spaced apart vertically from one another.

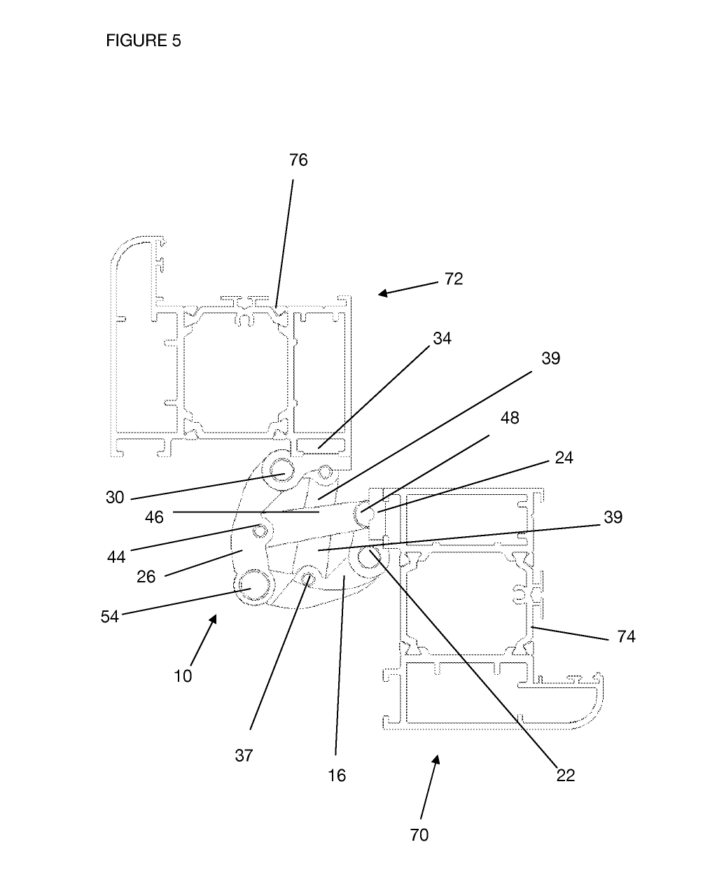

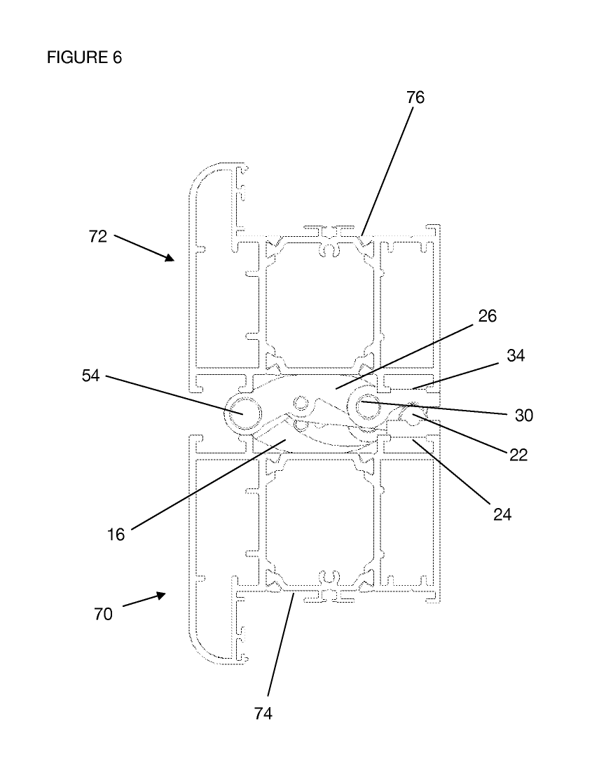

The first and second support members 46, 39, 41 are arms that provide bracing support between the first 12 and second 14 leaves of the hinge 10, such that as the leaves pivot relative to one another, the first body 16 and second body 26 are held at the desired angle relative to each other, so that the hinge 10 folds on itself as shown in FIGS. 4 to 6 of the drawings. FIG. 4 shows the hinge 10 in its open configuration in which the door panels 70, 72 are held parallel one another, with the bodies (not shown) of the respective door panels extending from the slots indicated at 74 and 76, respectively. FIG. 5 shows an intermediate position, and FIG. 6 shows the hinge 10 in its closed configuration, in which the door panels are held in line with one another (such that the door is closed). In each configuration, the first and second support members 46, 39, 41 hold parts of the first body 16 and second body 26 at a fixed distance from the first and second connection parts 24, 34, respectively, thus maintaining the desired shape of the hinge 10 at each stage.

The connection parts 24, 34 provide formations to secure a door panel relative to the hinge, as is known in the art. Such formations include clips, apertures for receiving screws, bolts, or the like, channels for sliding engagement with a part of the panel, or any other securing formation. When the hinge 10 is in its open configuration, the formations provided by the respective connection parts 24, 34 are disposed substantially in the same plane as each other so that the door panels extend from the hinge substantially parallel one another. When in its closed configuration, the formations are disposed substantially at 180 degrees to one another so that the panels extend from the hinge in opposite directions, so as to lie substantially in the same plane.

Each pivoting connection provided between the first and second bodies 16, 26 and the respective support members 46, 39, 41 and connection parts 24, 34, is preferably formed by a pin and bush connection. In other words, a bush is provided at each end of each of the support members 46, 39, 41, and a pin is held within the bush, for connection with a further bush provided on the part to which the support member is connected.

For example, with reference to FIGS. 1 and 2 of the drawings, the first support member 46 is pivotally connected at its first end to the first body 16, via a pin engaged with a bush 44 defined in the first body 16 and with a bush defined by the first end of the first support member 46. At its second end the first support member 46 defines another bush engaged with a pin 48 for connection with a pair of bushes defined in the second connection part 34 (not shown).

A first one of the pair of second support members 39 is pivotally connected at its first end to second body 26. A bush is defined at the first end of that support member 39 which engages with a pin held on the second body 26, to allow relative rotation between that support member 39 and the second body 26. At its second end, the second support member 39 provides another bush engaged with a pin 40, for connection with a further bush defined in the first connection part 24 (not shown) with which the support member 39 is connected (and is illustrated in FIGS. 4 to 6).

The other second support member 41 has a similar configuration, in which it is connected at its first end to the second body 26 via a bush 45 engaged with a pin held on the second body 26. At its second end, the support member provides a bush engaged with a pin 42, for connection to the first connection part 24.

In each case one of the pin and bush is provided on one of the parts and the other of the pin and bush is provided on the other of the respective parts. For each support member 46, 39, 41, the bush provided at its first end for connection to the respective first or second body 16, 26 is preferable formed of a bearing material that will allow a small amount of flex (e.g. HD polyurethane) to allow slight deformation, which in turn allows for slight movement of the respective pivoting axes during use. At the second end of each support member 46, 39, 41 for connection to the respective first or second connection part 24, 34 the bushes are preferably formed of a rigid bearing material (such as an acetal material) to ensure smooth movement of the pins in the bushes, and to minimise wear during use.

When such hinges 10 are installed on a multi-panel door, it is envisaged that one or more hinges may be connected between each pair of adjacent panels. For example, two or three hinges 10 may be aligned vertically above one another, spaced apart from one another, to provide the required strength to support the door panels. Where the longitudinal axes of the respective pivot pins 58 are not exactly in alignment, it is preferable to allow slight flexibility in the alignment of the respective axes of rotation of the hinges 10.

To achieve such flexibility, a bearing 60 is provided which defines an opening for receiving a first portion 58a of the pivot pin 58. The bearing 60 is a ‘convex bearing’, which as described before, means that it provides a surface that is curved in more than one plane, thereby forming a domed surface. In embodiments, for example, the bearing 60 is a ball bearing.

In embodiments, and as shown in FIG. 3, the opening defined by the bearing 60 is an aperture defined through the bearing 60, such that the pivot pin 58 extends through the bearing 60 (i.e. through a diameter of the bearing 60). In alternative embodiments, a different portion of the pivot pin 58, such as a portion towards one or other end of the pin, is received in the opening, in which case the opening may be a recess rather than an aperture through the bearing 60. In such a configuration the pivot pin 58 extends into the bearing 60 but does not pass through it.

In embodiments, the first leaf 12 of the hinge 10 provides a seat 65 for rotatably retaining the bearing 60 within the first retaining portion 28. In other words, the seat 65 is configured so that the bearing 60 is free to rotate, but is otherwise restricted in its movement. In embodiments, the bearing 60 cannot move relative to the seat 65 other than by rotation. In embodiments, the first bearing bush arrangement 63 provides the seat 65 for retaining the bearing 60. It should be understood that the bearing 60 should be rounded to the extent that it is able to engage the seat 65 for rotation relative to the seat 65 (i.e. it must provide a convex surface for engagement with a concave surface of the seat).

The first leaf 12 provides a first bearing bush arrangement 63 positioned substantially within the first retaining portion 28 and which surrounds the first portion 58a of the pivot pin 58. The first bearing bush arrangement 63 forms a sleeve adapted to surround the pivot pin 58 so as to allow the pivot pin 58 to rotate about its longitudinal axis. In embodiments the internal diameter of the first bearing bush arrangement 63 is larger than the diameter of the pivot pin 58 so as to provide a gap 67, or at least room for movement, between the pivot pin 58 and the first bearing bush arrangement 63. The gap 67 enables angular movement of the pivot pin 58, about an axis perpendicular to its longitudinal axis, within the first bearing bush arrangement 63. The difference between the internal diameter of the first bearing bush arrangement 63 and the diameter of the pivot pin 58 may be less than 2 mm. Preferably, the difference is between 0.1 mm and 1 mm. In embodiments in which the pivot pin 58 extends through the bearing 60, as shown, and where such a gap 67 exists, the pivot pin may be able to undergo angular rotation about an axis perpendicular to its longitudinal axis by up to 3 degrees, .and preferably by approximately 1 degree (and such that the rotation is limited to at most 3 degrees, or 1 degree, respectively).

With reference to FIG. 3, the first bearing bush arrangement 63 comprises a first part 63a and a second part 63b each having a bearing-facing end, and an outer end facing away from the bearing 60. Each of the first part 63a and second part 63b is formed as a sleeve having an outer surface and an inner surface.

The respective bearing-facing ends each form a concave rim to abut a surface of the bearing 60 such that the seat 65 is formed between the bearing-facing ends of the first part 63a and second part 63b of the first bearing bush arrangement 63. By “concave rim” it is meant that the rim formed at the end of the sleeve, between its inner and outer surface, is shaped to conform to the convex surface of the bearing 60. In other embodiments, the rims of the bearing-facing ends may be chamfered so as to abut the bearing 60, without the rims being curved.

In this manner, the bearing-facing ends of the respective first part 63a and second part 63b define the seat 65, adapted to fit against opposite sides of the bearing 60 to hold it in position while allowing it to rotate.

A second bearing bush 62 is positioned substantially within the second retaining portion 18, and surrounds the second portion 58b of the pivot pin 58. A bearing-facing end of the second bearing bush 62 abuts the outer end of the first part 63a of the first bearing bush arrangement 63. The first bearing bush arrangement 63 abuts the second bearing bush 62 at a first bearing surface 66. The first portion 58a and second portion 58b of the pivot pin 58 lie at different positions along the length of the pivot pin 58, such that no overlap (or substantially no overlap) occurs between them. In this way, substantially no overlap occurs between the first and second bearing bushes 63, 62 along the length of the pivot pin 58. The term ‘substantially no overlap’ refers to the position at which respective bearing bushes meet, at which a portion of a concave surface may overlie a portion of a convex surface, along the length of the pivot pin 58. However, the extent of such overlap is negligible.

In embodiments, and as shown, a third bearing bush 64 is positioned substantially within the third retaining portion 20, and surrounds the third portion 58c of the pivot pin 58. A bearing-facing end of the third bearing bush 64 abuts the respective outer end of the second parts 63b of the first bearing bush arrangement 63. The first bearing bush arrangement 63 abuts the third bearing bush 64 at a second bearing surface 68. Again, the first portion 58a and third portion 58c (and, also, second portion 58b) of the pivot pin 58 lie at different positions along the length of the pivot pin 58, such that no overlap (or substantially no overlap) occurs between them. In this way, substantially no overlap occurs between the first, second and/or third bearing bushes 63, 62, 64 along the length of the pivot pin 58.

At the first bearing surface 66, the outer end of the first part 63a of the first bearing bush arrangement 63 provides a rim that extends radially outwardly. The rim is a convex rim, such that the curvature of the rim is concentric with the bearing 60 (i.e. with its centre of curvature lying at the centre point of the bearing). The bearing-facing end of the second bearing bush 62 is shaped to conform to the convex rim of the outer end of the first part 63a. The bearing-facing end of the second bearing bush 62 extends radially outwardly in the same manner as before described, and abuts and bears against the outer end of the first part 63a. An identical configuration is provided at the second bearing surface 68, at which the outer end of the second part 63b of the first bearing bush arrangement has an outwardly radially extending convex rim, which bears against a concave outwardly extending rim at the bearing-facing end of the third bearing bush 64.

The first, second and third bearing bushes 63, 62, 64 are preferably formed from a suitable rigid bearing material (e.g. an acetal material), to ensure smooth rotation of the pivot pin 58 within the bushes 62, 63, 64, and allow a long service life.

In embodiments, a stopper 54, 56 is provided at each end of the channel formed by the retaining portions 18, 20, 28, to prevent the pivot pin 58 leaving the channel.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A hinge comprising:
a first leaf for connection to a first object and a second leaf for connection to a second object,
a pivot pin, and
a convex bearing defining an opening for receiving a portion of the pivot pin,
the first leaf including a first retaining portion surrounding a portion of the pivot pin, and the second leaf including a second retaining portion surrounding a portion of the pivot pin, for relative rotation of the first leaf and second leaf about an axis of rotation defined by the pivot pin, the axis of rotation being rotatable about the bearing.

2. A hinge according to claim 1 wherein the convex bearing is a ball bearing.

3. A hinge according to claim 1 wherein the first leaf provides a seat for rotatably retaining the convex bearing within the first retaining portion.

4. A hinge according to claim 3 wherein the first leaf provides a first bearing bush arrangement positioned substantially within the first retaining portion and which surrounds a first portion of the pivot pin.

5. A hinge according to claim 4 wherein the first bearing bush arrangement provides the seat.

6. A hinge according to any one of claim 4 wherein the internal diameter of the first bearing bush arrangement is larger than the diameter of the pivot pin so as to enable angular movement of the pivot pin within the first bearing bush arrangement about an axis perpendicular to its longitudinal axis.

7. A hinge according to claim 6 wherein the difference between the internal diameter of the first bearing bush arrangement and the diameter of the pivot pin is between 0.1 mm and 1 mm.

8. A hinge according to claim 5 wherein the first bearing bush arrangement comprises a first part and a second part each having a bearing-facing end and an outer end, the bearing-facing ends each forming a concave rim to abut a surface of the convex bearing such that the seat is formed between the bearing-facing ends of the first part and second part of the first bearing bush arrangement.

9. A hinge according to claim 1, wherein the opening defined by the convex bearing is an aperture defined through the convex bearing, and the pivot pin extends through the convex bearing.

10. A hinge according to claim 8 wherein the second leaf includes a third retaining portion surrounding a third portion of the pivot pin.

11. A hinge according to claim 10 wherein the second portion of the pivot pin is disposed towards a first end of the pivot pin and the third portion of the pivot pin is disposed towards a second end of the pivot pin opposite to the first end.

12. A hinge according to claim 11 wherein the first retaining portion is disposed between the second and third retaining portions and the first portion of the pivot pin is disposed centrally lengthwise of the pivot pin.

13. A hinge according to claim 10 wherein the outer ends of the first and second parts of the first bearing bush arrangement each form convex rims adapted to abut a corresponding concave ring formed at respective bearing-facing ends of second and third bearing bushes positioned substantially within the second and third retaining portions, respectively, and surrounding second and third portions of the pivot pin.

14. A hinge according to claim 13 wherein the respective inner ends of the second and third bearing bushes each provide a rim that extends radially outwardly so as to abut an end of respective second and third retaining portions.

15. A hinge according to claim 1, wherein the first leaf includes:
a first body connected to the first retaining portion, and
a first connection part for connection to the first object, the first connection part being pivotally connected to the first body, and the second leaf includes:
a second body connected to the second retaining portion and third retaining portions, and
a second connection part for connection to the second object, the second connection part being pivotally connected to the second body.

16. A hinge according to claim 15 wherein the hinge further includes a first support member having a first end and a second end, the first end being pivotally connected to the first body and the second end being pivotally connected to the second leaf.

17. A hinge according to claim 16 wherein the hinge further includes a second support member having a first end and a second end, the first end being pivotally connected to the second body and the second end being pivotally connected to the first leaf.

18. A hinge according to claim 17 wherein the hinge includes a pair of second support members.

19. A hinge according to claim 17, wherein the first support member is connected at its second end to the second connection part, and the second support member(s) is connected at its second end to the first connection part.

20. A door comprising a first and a second door panel, the first and second door panels being connected to one another using a hinge according to claim 1.
